(19) United States
(12) Patent Application Publication
(10) Pub. No.: US 2026/0208665 A1
(43) Pub. Date: Jul. 23, 2026

(54) Continuous Monitoring Trailer Adapter

(71) Applicants: David Christ, Staunton, VA (US); Lynette Christ, Staunton, VA (US)

(72) Inventors: David Christ, Staunton, VA (US); Lynette Christ, Staunton, VA (US)

(21) Appl. No.: 19/030,775

(22) Filed: Jan. 17, 2025

(51) Int. Cl. B60Q 1/30; B60Q 1/52

(52) U.S. Cl. CPC B60Q 1/305; B60Q 1/52

(57) ABSTRACT

A disclosed trailer safety system for a vehicle includes a portable light display for a back of the trailer configured to monitor a status of a turning, a braking, a backing and a running of the trailer. A voltage circuit monitors a change in voltage across a power and a ground wiring of the portable light display. A case for the voltage circuit comprises lights on a lid of the case configured to include a no load safety light and a short circuit safety light.

### BACKGROUND

Most trailers are attached to a vehicle with electrical connections allowing for a trailer to have the same light signals as the vehicle towing the trailer. Although this increases safety and indeed is required by law, maintaining a parasitic electrical system is problematic. There have been no products available as original equipment or as an aftermarket to address this problem.

### SUMMARY OF THE INVENTION

A disclosed trailer safety system for a vehicle includes a portable light display for a back of the trailer configured to monitor a status of a turning, a braking, a backing and a running of the trailer. A voltage circuit monitors a change in voltage across a power and a ground wiring of the portable light display. A case for the voltage circuit comprises lights on a lid of the case configured to include a no load safety light and a short circuit safety light.

### BRIEF DESCRIPTION OF THE DRAWINGS

FIG. 1 is a schematic depiction of the continuous monitoring trailer adapter installed on a trailer in accordance with an embodiment of the present disclosure.

FIG. 2 is pictorial depiction of a case for receiving monitoring circuits and displaying monitoring lights in accordance with an embodiment of the present disclosure.

FIG. 3 is a pictorial depiction of the portable light display of which a pair is mounted to the back of the trailer in accordance with an embodiment of the present disclosure.

FIG. 4 is a perspective view of a towing vehicle side adapter plug in accordance with an embodiment of the present disclosure.

FIG. 5 is a perspective view of a trailer side adapter plug in accordance with an embodiment of the present disclosure.

Throughout the description, similar reference numbers may be used to identify similar elements depicted in multiple embodiments. Although specific embodiments of the invention have been described and illustrated, the invention is not to be limited to the specific forms or arrangements of parts so described and illustrated. The scope of the invention is to be defined by the claims appended hereto and their equivalents.

### DETAILED DESCRIPTION

Reference will now be made to exemplary embodiments illustrated in the drawings and specific language will be used herein to describe the same. It will nevertheless be understood that no limitation of the scope of the disclosure is thereby intended. Alterations and further modifications of the inventive features illustrated herein and additional applications of the principles of the inventions as illustrated herein, which would occur to one skilled in the relevant art and having possession of this disclosure, are to be considered within the scope of the invention.

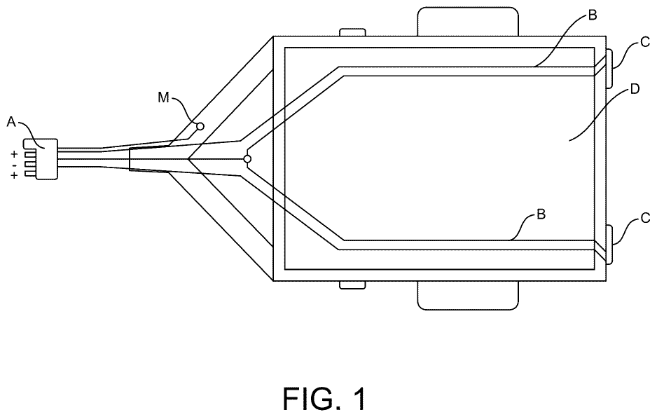

FIG. 1 is a schematic depiction of the continuous monitoring trailer adapter installed on a trailer in accordance with an embodiment of the present disclosure. The depiction includes the light plug adapter A, the trailer power and ground wiring B to two rear portable light displays C. The trailer D is used as a chassis ground M to the electrical circuits of the trailer. The left portable light display and the right portable light display share a common ground labeled “−” between the two “+” signs on the light plug adapter A. In fact, the voltage monitored by the disclosure is a voltage across a plus sign and a common negative sign which are in parallel to the two lights. Embodiments include separate grounds for the two portable display lights to separately monitor a left and a right portable display light.

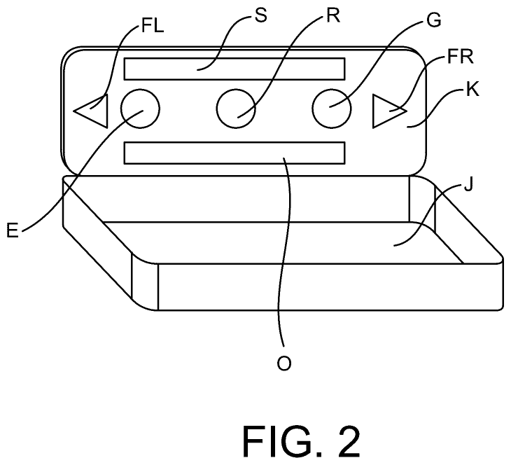

FIG. 2 is pictorial depiction of a case for receiving monitoring circuits and displaying monitoring lights in accordance with an embodiment of the present disclosure. The depiction includes the right blinker FR, the left blinder FL, the red brake light E, the blue running light G, the backing light R, the short circuit light S and the open or no load light O. The lid K is open for a display of the lights and the voltage and the monitoring circuits are built into the lid. The base of the lid J is mountable to a dashboard of the vehicle for display to a driver. The case J and K close to store a wiring adapter.

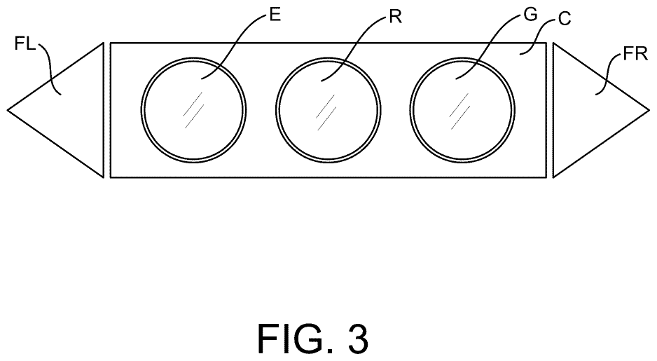

FIG. 3 is a pictorial depiction of the portable light display of which a pair is mounted to the back of the trailer in accordance with an embodiment of the present disclosure. The portable light display C screen includes the right turn signal FR, the left turn signal FL, the red brake light E, the backing light R, and the running light G. A pair of portable light displays C is placed at the rear left and the rear right of the trailer in most cases but a third portable light display is also used in embodiments higher up on the trailer for more visibility to other drivers.

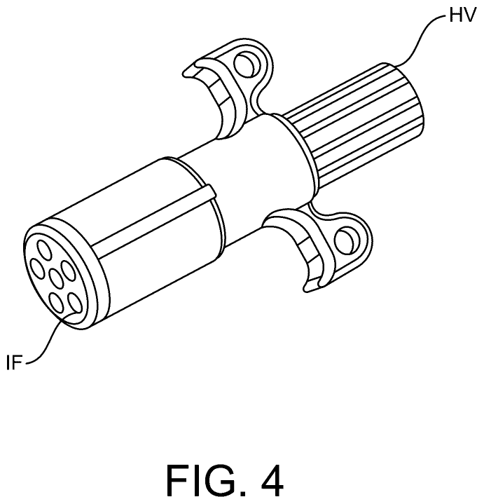

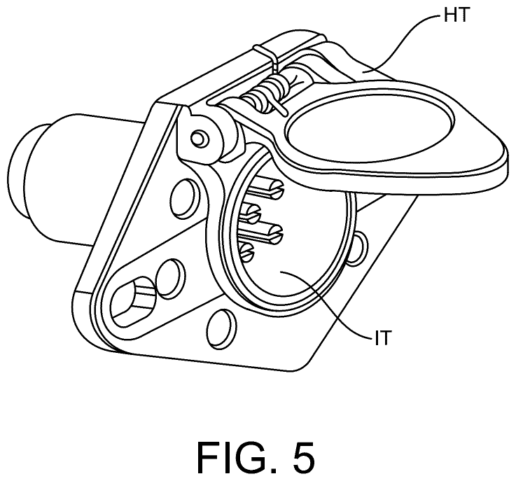

FIG. 4 is a perspective view of a towing vehicle side adapter plug in accordance with an embodiment of the present disclosure. The depiction includes the trailer adapter plug HV leading to the towing vehicle for connection with the disclosed voltage and monitoring circuits and monitoring lights. The female side IF of the adapter hooks to the male side of the adapter mounted on the trailer as per FIG. 5 below.

FIG. 5 is a perspective view of a trailer side adapter plug in accordance with an embodiment of the present disclosure. The trailer side adapter HT is mounted to the trailer and comprises the male side IT of the electrical connection for the continuous monitoring of the trailer portable light display(s).

The Continuous Monitoring Trailer Adapter enhances road safety by providing real-time monitoring of trailer lighting systems. Traditional trailer light plug adapters do not offer any feedback on the operational status of trailer lights, leaving drivers unaware of potential issues such as open circuits including loose connections or malfunctioning bulbs. This lack of awareness can lead to dangerous situations, as non-functioning brake lights or blinkers can significantly increase the risk of accidents, forcing tailgaters and surrounding vehicles to brake instantly in response to present traffic.

The Continuous Monitoring Trailer Adapter offers an auto accessory designed to detect any change in voltage that indicates problems with braking lights or blinkers utilized on a trailer. Effectively providing immediate audible and visual alerts, as well as notifications through a portable display screen, a mobile app, or the vehicle's on-board display panel, the Continuous Monitoring Trailer Adapter ensures that drivers are promptly informed of any real time issues. This proactive approach helps prevent potential hazards, ensuring that the trailer's lighting system remains operational and compliant with safety regulations.

Promoting trailer safety and maintenance, this accessory is complementary to diverse makes and models and serves to mitigate the issue of insufficient awareness regarding trailer light malfunctions by continuously monitoring the trailer's electrical system and providing immediate alerts if a problem is detected; thus making it easier for drivers to quickly identify and address problems enhancing both the safety of the primary driver and other automotive operators sharing the road, simultaneously. Ultimately, the Continuous Monitoring Trailer Adapter helps drivers adhere to trailer lighting system regulations, preventing potential legal and financial consequences, while also supporting proactive maintenance and troubleshooting.

The disclosed patent technology is used on tractor trailers, semi trailers and 18 wheelers and any large vehicles on the interstates and road systems throughout the world. The disclosure can be used on all towable vehicles on various road systems. Notwithstanding, federal and state laws, the disclosed technology makes all road systems safer for all drivers.

Although the operations of the method(s) herein are shown and described in a particular order, the order of the operations of each method may be altered so that certain operations may be performed in an inverse order or so that certain operations may be performed, at least in part, concurrently with other operations. In another embodiment, instructions or sub-operations of distinct operations may be implemented in an intermittent and/or alternating manner.

While the forgoing examples are illustrative of the principles of the present disclosure in one or more particular applications, it will be apparent to those of ordinary skill in the art that numerous modifications in form, usage and details of implementation can be made without the exercise of inventive faculty, and without departing from the principles and concepts of the invention. Accordingly, it is not intended that the disclosure be limited, except as by the specification and claims set forth herein.

What is claimed is:

1. A trailer safety system for a vehicle comprising: a portable light display for a back of the trailer and configured to monitor a status of a turning, a braking, and a running of the trailer; a voltage circuit configured to monitor a change in voltage across a power and a ground wiring of the portable light display; and a case for the voltage circuit and comprising lights on a lid of the case configured to include a no load safety light and a short circuit safety light.

2. The system of claim 1, further comprising a pair of the portable light displays for a back left and a back right of the trailer.

3. The system of claim 1, wherein the portable light display further comprises a light triggered by a backing of the trailer.

4. The system of claim 1, wherein the portable light display comprises a light for each of the turning, the braking and the running of the trailer.

5. The system of claim 1, wherein the voltage circuit is a differential circuit configured to detect a short circuit voltage lower than a reference voltage.

6. The system of claim 1, wherein the voltage circuit is a differential circuit configured to detect a no load voltage higher than a reference voltage.

7. The system of claim 1, wherein the no load safety light is triggered by no current through the power and the ground wiring of the portable light display.

8. The system of claim 1, wherein the no load safety light is triggered by a high voltage across the power and the ground wiring in relation to a loaded voltage across the portable light display.

9. The system of claim 1, wherein the short circuit safety light is triggered by a low voltage across the power and the ground wiring in relation to a loaded voltage across the portable display.

10. The system of claim 1, wherein the short circuit safety light is triggered by a high current through the power and the ground wiring in relation to a loaded current through the portable light display.

11. The system of claim 1, wherein a base of the case is configured to be mounted on a front dashboard of the vehicle.

12. The system of claim 1, wherein the case further defines a cavity to receive a wiring adapter for the disclosure.

13. The system of claim 1, wherein a power supply for the portable light display and the voltage circuit are the same power supply.

14. The system of claim 1, wherein a loaded voltage across the power and ground of the portable light display is determined based on a known working state of the portable light display.

15. The system of claim 1, wherein a loaded current through the power and ground of the portable light display is determined based on a known working state of the portable light display.
